(19) United States
(12) Patent Application Publication
(10) Pub. No.: US 2012/0047749 A1
(43) Pub. Date: Mar. 1, 2012

(54) Pruning Hook Performing a Shearing Action Step by Step

(76) Inventor: Yao-Chung Huang, Changhua Hsien (TW)

(21) Appl. No.: 12/872,013

(22) Filed: Aug. 31, 2010

(51) Int. Cl. A01G 3/08; B26B 13/26

(52) U.S. Cl. 30/249; 30/258; 30/261

(57) ABSTRACT

A pruning hook includes a fixed seat, a cutter pivotally mounted on the fixed seat, a link connected with the cutter, a drive arm pivotally mounted on the fixed seat and connected with the link, a pull cord connected with the drive arm, and a restoring spring biased between the fixed seat and the drive arm. The cutter has a sliding slot provided with a plurality of locking teeth. A driving bolt secured on the link is movable in the sliding slot and is detachably locked onto one of the locking teeth. Thus, when the pull cord is pulled and slightly loosened in a staggered manner, the driving bolt is driven to engage each of the locking teeth to drive the cutter to pierce an object step by step, so that the cutter can shear the object in a multi-stage manner.

### BACKGROUND OF THE INVENTION

1. Field of the Invention

The present invention relates to a gardening tool and, more particularly, to a pruning hook to shear a plant, such as a tree and the like.

2. Description of the Related Art

A conventional pruning hook is used to shear branches of a tree at a higher location. However, the conventional pruning hook can only applies a determined shearing force so that when the branches have larger sizes, the conventional pruning hook cannot shear the larger branches easily and quickly, thereby greatly causing inconvenience to the user when shearing the branches.

### BRIEF SUMMARY OF THE INVENTION

In accordance with the present invention, there is provided a pruning hook, comprising a fixed seat, a cutter pivotally mounted on the fixed seat, a link connected with the cutter to move the cutter relative to the fixed seat, a drive arm pivotally mounted on the fixed seat and connected with the link to move the link relative to the fixed seat, a pull cord connected with the drive arm to move the drive arm relative to the fixed seat, and a restoring spring biased between the fixed seat and the drive arm.

The fixed seat has a hollow inside formed with a receiving chamber. The fixed seat has a side formed with a recessed entrance connected to the receiving chamber. The fixed seat has a mediate portion formed with a first pivot hole and a second pivot hole. The cutter is pivotally mounted in the receiving chamber of the fixed seat. The cutter has an upper portion formed with a sliding slot and a lower portion provided with a cutting blade. The sliding slot of the cutter has a side provided with a plurality of locking teeth. The cutter has a mediate portion formed with a third pivot hole pivotally connected with the first pivot hole of the fixed seat by a first pivot member. The drive arm has a hollow inside formed with a mounting chamber pivotally mounted on the fixed seat. The drive arm has a lower portion formed with a fourth pivot hole pivotally connected with the second pivot hole of the fixed seat by a second pivot member. The drive arm has a mediate portion formed with a fifth pivot hole and provided with a stop rod. The link is pivotally mounted in the mounting chamber of the drive arm. The link has a first end provided with a stop portion abutting the stop rod of the drive arm and a second end formed with a fixing hole. The link has a mediate portion formed with a sixth pivot hole pivotally connected with the fifth pivot hole of the drive arm by a third pivot member. The link has a hollow inside formed with an opening to allow passage of the cutter. The pruning hook further comprises a driving bolt extending through the fixing hole of the link, the opening of the link and the sliding slot of the cutter to combine the link and the cutter and to move the cutter by movement of the link. The driving bolt is movable in the sliding slot of the cutter and is detachably locked onto one of the locking teeth of the sliding slot.

The primary objective of the present invention is to provide a pruning hook performing a shearing action step by step.

According to the primary advantage of the present invention, when the pull cord is pulled and slightly loosened in a staggered manner, the driving bolt is driven to in turn engage each of the locking teeth of the sliding slot to drive the cutter by multiple stages so as to pierce the object step by step, so that the cutter can shear the object in a multi-stage manner without having to apply a larger force to shear the object, thereby facilitating the operator shearing the object, and thereby saving the operator's energy.

According to another advantage of the present invention, after the driving bolt is moved backward to proceed the next cutting action, the stop portion of the link is stopped by the stop rod of the drive arm to prevent the cutter from being moved backward by the reaction force applied by the object so that the driving bolt is driven to engage each of the locking teeth of the sliding slot exactly and smoothly, thereby facilitating the operator performing the multi-stage shearing action.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pruning hook in accordance with the preferred embodiment of the present invention.

FIG. 2 is an exploded perspective view of the pruning hook as shown in FIG. 1.

FIG. 3 is a side view of the pruning hook as shown in FIG. 1.

FIG. 4 is a schematic operational view of the pruning hook as shown in FIG. 3 in use.

FIG. 5 is a schematic operational view of the pruning hook as shown in FIG. 4 in use.

FIG. 6 is a schematic operational view of the pruning hook as shown in FIG. 5 in use.

FIG. 7 is a schematic operational view of the pruning hook as shown in FIG. 6 in use.

FIG. 8 is a schematic operational view of the pruning hook as shown in FIG. 7 in use.

### DETAILED DESCRIPTION OF THE INVENTION

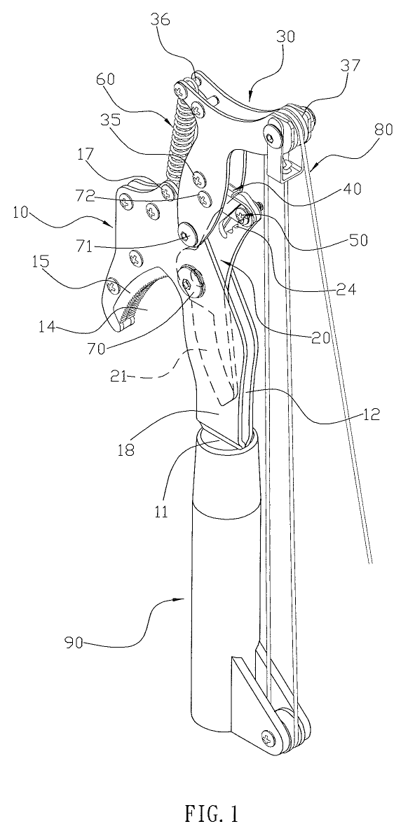

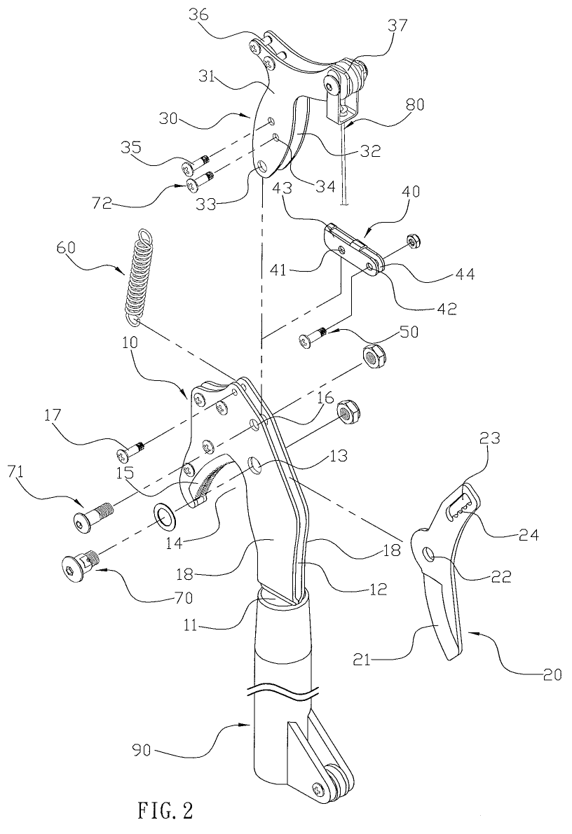

Referring to the drawings and initially to FIGS. 1-3, a pruning hook in accordance with the preferred embodiment of the present invention comprises a fixed seat 10, a cutter 20 pivotally mounted on the fixed seat 10, a link 40 connected with the cutter 20 to move the cutter 20 relative to the fixed seat 10, a drive arm 30 pivotally mounted on the fixed seat 10 and connected with the link 40 to move the link 40 relative to the fixed seat 10, a pull cord 80 connected with the drive arm 30 to move the drive arm 30 relative to the fixed seat 10, and a restoring spring 60 biased between the fixed seat 10 and the drive arm 30.

The fixed seat 10 has a hollow inside formed with a receiving chamber 12. The fixed seat 10 has a side formed with a recessed entrance 14 connected to the receiving chamber 12. The fixed seat 10 has a mediate portion formed with a first pivot hole 13 and a second pivot hole 16. The second pivot hole 16 of the fixed seat 10 is located above the first pivot hole 13 of the fixed seat 10, and the first pivot hole 13 of the fixed seat 10 is located above the entrance 14 of the fixed seat 10. The fixed seat 10 has a periphery provided with a first fixing member 17. The first fixing member 17 of the fixed seat 10 is extended through the receiving chamber 12 of the fixed seat 10 and is located above the second pivot hole 16 of the fixed seat 10. The fixed seat 10 is composed of two bent sheet plates 18 which are spaced from each other, and the receiving chamber 12 of the fixed seat 10 is defined between the two bent sheet plates 18. The fixed seat 10 has a lower portion formed with a bent connecting section 11 which is inserted into an upper end of an extension shank 90. The entrance 14 of the fixed seat 10 has a side formed with an anvil 15.

The cutter 20 is pivotally mounted in the receiving chamber 12 of the fixed seat 10. The cutter 20 has a substantially arc-shaped profile and has an upper portion formed with a sliding slot 23 and a lower portion provided with a cutting blade 21. The sliding slot 23 of the cutter 20 has a side provided with a plurality of locking teeth 24. The locking teeth 24 of the sliding slot 23 and the cutting blade 21 of the cutter 20 are located at two opposite sides of the cutter 20. The cutting blade 21 of the cutter 20 is movable in the receiving chamber 12 of the fixed seat 10 and is extendable into the entrance 14 of the fixed seat 10 to move toward the anvil 15 of the fixed seat 10. The cutter 20 has a mediate portion formed with a third pivot hole 22 pivotally connected with the first pivot hole 13 of the fixed seat 10 by a first pivot member 70. The third pivot hole 22 of the cutter 20 is located between the sliding slot 23 and the cutting blade 21 of the cutter 20.

The drive arm 30 is composed of two substantially T-shaped sheet plates 31 which are spaced from each other. The drive arm 30 has a hollow inside formed with a mounting chamber 32 pivotally mounted on the fixed seat 10. The mounting chamber 32 of the drive arm 30 is defined between the two sheet plates 31 of the drive arm 30. The drive arm 30 has a lower portion formed with a fourth pivot hole 33 pivotally connected with the second pivot hole 16 of the fixed seat 10 by a second pivot member 71. The drive arm 30 has a mediate portion formed with a fifth pivot hole 34 and provided with a stop rod 35. The stop rod 35 of the drive arm 30 is extended through the mounting chamber 32 of the drive arm 30 and is located above the fifth pivot hole 34 of the drive arm 30. The fifth pivot hole 34 of the drive arm 30 is located above the fourth pivot hole 33 of the drive arm 30. The drive arm 30 has an upper portion having a first side provided with a second fixing member 36 and a second side provided with a driving portion 37. The second fixing member 36 of the drive arm 30 is extended through the mounting chamber 32 of the drive arm 30 and is located above the stop rod 35 of the drive arm 30.

The pull cord 80 is connected with the driving portion 37 of the drive arm 30 to drive the drive arm 30 to pivot about the second pivot member 71.

The restoring spring 60 has an upper end secured on the second fixing member 36 of the drive arm 30 and a lower end secured on the first fixing member 17 of the fixed seat 10.

The link 40 is pivotally mounted in the mounting chamber 32 of the drive arm 30. The link 40 has a first end provided with a stop portion 43 abutting the stop rod 35 of the drive arm 30 and a second end formed with a fixing hole 42. The link 40 has a mediate portion formed with a sixth pivot hole 41 pivotally connected with the fifth pivot hole 34 of the drive arm 30 by a third pivot member 72. The sixth pivot hole 41 of the link 40 is located between the stop portion 43 and the fixing hole 42 of the link 40. The link 40 has a hollow inside formed with an opening 44 to allow passage of the cutter 20. The fixing hole 42 of the link 40 is connected to the opening 44 of the link 40.

The pruning hook further comprises a driving bolt 50 extending through the fixing hole 42 of the link 40, the opening 44 of the link 40 and the sliding slot 23 of the cutter 20 to combine the link 40 and the cutter 20 and to move the cutter 20 by movement of the link 40. The driving bolt 50 is movable in the sliding slot 23 of the cutter 20 and is detachably locked onto one of the locking teeth 24 of the sliding slot 23.

In practice, the sixth pivot hole 41 of the link 40 is pivotally connected with the fifth pivot hole 34 of the drive arm 30 by the third pivot member 72, and the fixing hole 42 of the link 40 is pivotally connected with the sliding slot 23 of the cutter 20 by the driving bolt 50 so that the cutter 20, the drive arm 30 and the link 40 are connected to construct a linkage and are moved in concert with each other.

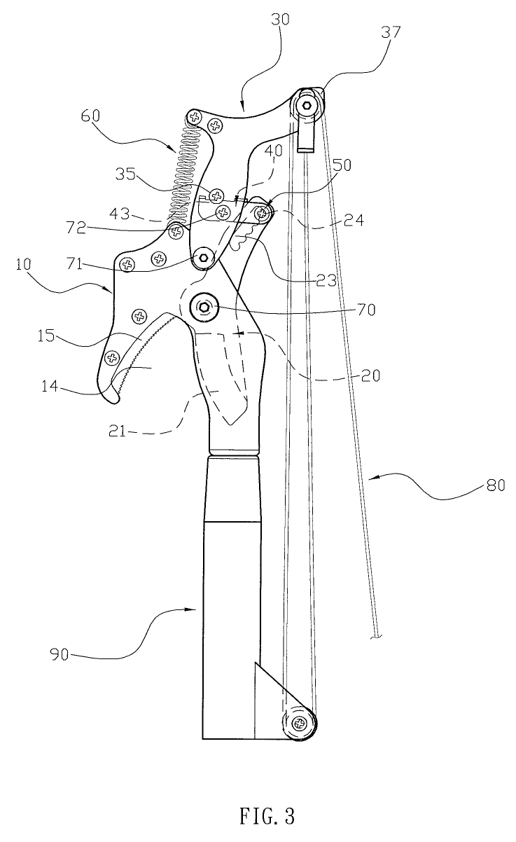

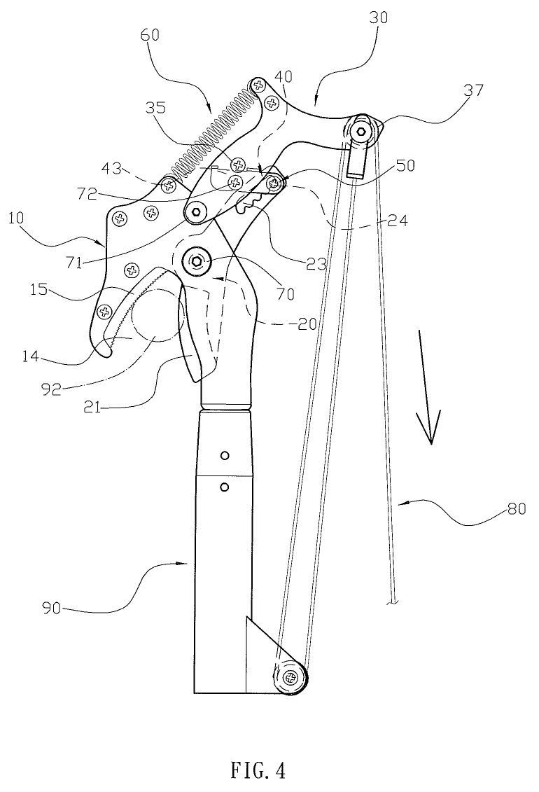

In operation, referring to FIGS. 4-8 with reference to FIGS. 1-3, the restoring spring 60 is biased between the fixed seat 10 and the drive arm 30 to pull the drive arm 30 which moves the link 40 which moves the cutter 20 which moves the cutting blade 21 so that the cutting blade 21 of the cutter 20 is extended into the receiving chamber 12 of the fixed seat 10 and is spaced from the entrance 14 of the fixed seat 10 as shown in FIG. 3. Then, an object 92, such as a branch and the like, is inserted into the entrance 14 of the fixed seat 10.

When the pull cord 80 is pulled downward, the drive arm 30 is pivoted downward about the second pivot member 71 to move the third pivot member 72 which moves the link 40 which moves the driving bolt 50 which presses a first one of the locking teeth 24 of the sliding slot 23 so that the cutter 20 is pivoted about the first pivot member 70, and the cutting blade 21 of the cutter 20 is moved through a first distance and is extended into the entrance 14 of the fixed seat 10 to shear the object 92 as shown in FIG. 4. At this time, the stop rod 35 of the drive arm 30 presses the stop portion 43 of the link 40 to support the link 40 so that the link 40 is pushed by the third pivot member 72 and is also pressed by the stop rod 35 of the drive arm 30 so as to drive the driving bolt 50 and the cutter 20 solidly and stably.

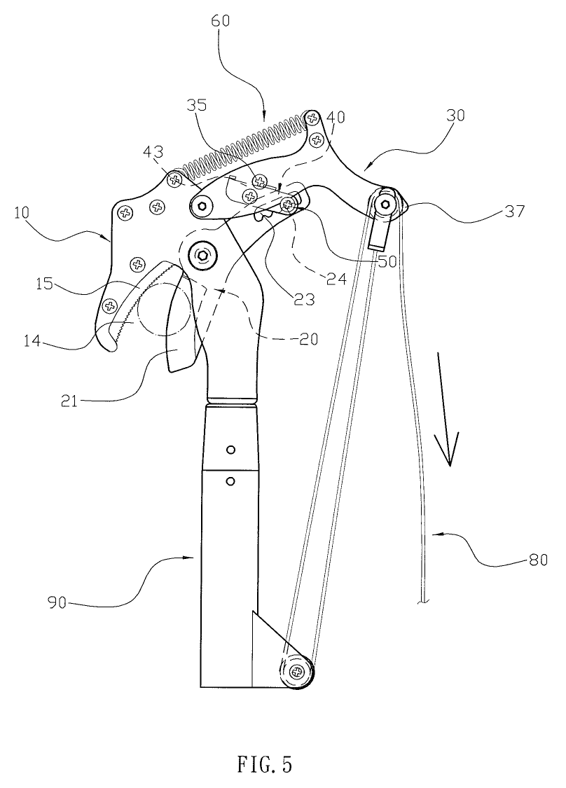

Then, when the pull cord 80 is slightly loosened, the drive arm 30 is slightly moved backward by the restoring force of the restoring spring 60 to move backward the third pivot member 72 which moves backward the link 40 which moves the driving bolt 50 so that the driving bolt 50 is detached from the first one of the locking teeth 24 of the sliding slot 23. At this time, the cutting blade 21 of the cutter 20 is inserted into the object 92 so that the cutter 20 cannot be moved backward. In addition, the stop portion 43 of the link 40 is stopped by the stop rod 35 of the drive arm 30 to stop movement of the driving bolt 50 so that the driving bolt 50 is forced to be inserted into a second one of the locking teeth 24 of the sliding slot 23 as shown in FIG. 5.

Then, when the pull cord 80 is again pulled downward, the drive arm 30 is pivoted downward to move the third pivot member 72 which moves the link 40 which moves the driving bolt 50 which presses the second one of the locking teeth 24 of the sliding slot 23 so that the cutter 20 is pivoted about the first pivot member 70, and the cutting blade 21 of the cutter 20 is moved through a second distance and is further extended into the entrance 14 of the fixed seat 10 to further shear the object 92 as shown in FIG. 5.

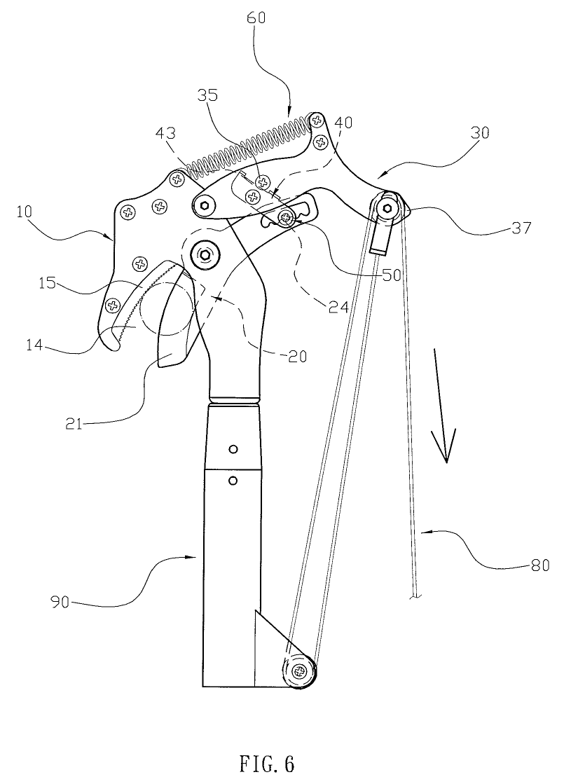

Then, when the pull cord 80 is slightly loosened, the driving bolt 50 is detached from the second one of the locking teeth 24 of the sliding slot 23 and is forced into a third one of the locking teeth 24 of the sliding slot 23 as shown in FIG. 6. Then, when the pull cord 80 is again pulled downward, the cutting blade 21 of the cutter 20 is moved through a third distance and is further extended into the entrance 14 of the fixed seat 10 to further shear the object 92 as shown in FIG. 6.

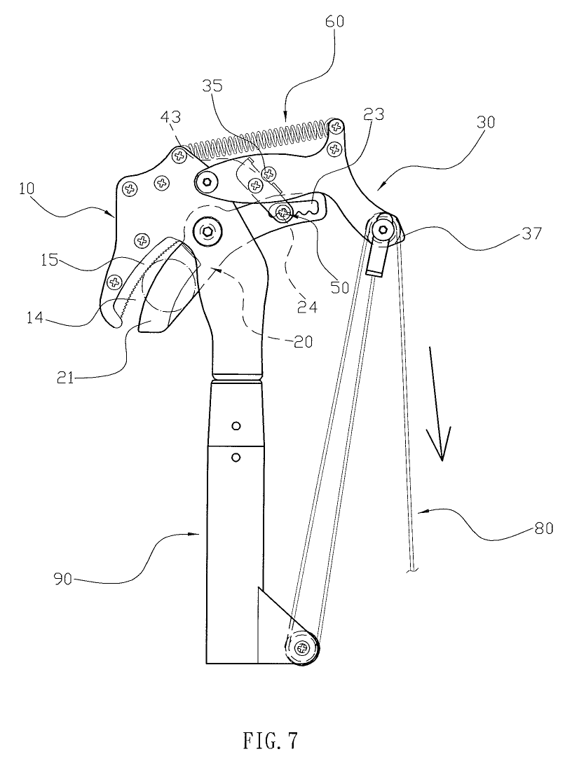

Then, when the pull cord 80 is slightly loosened, the driving bolt 50 is detached from the third one of the locking teeth 24 of the sliding slot 23 and is forced into a fourth one of the locking teeth 24 of the sliding slot 23 as shown in FIG. 7. Then, when the pull cord 80 is again pulled downward, the cutting blade 21 of the cutter 20 is moved through a fourth distance and is further extended into the entrance 14 of the fixed seat 10 to further shear the object 92 as shown in FIG. 7.

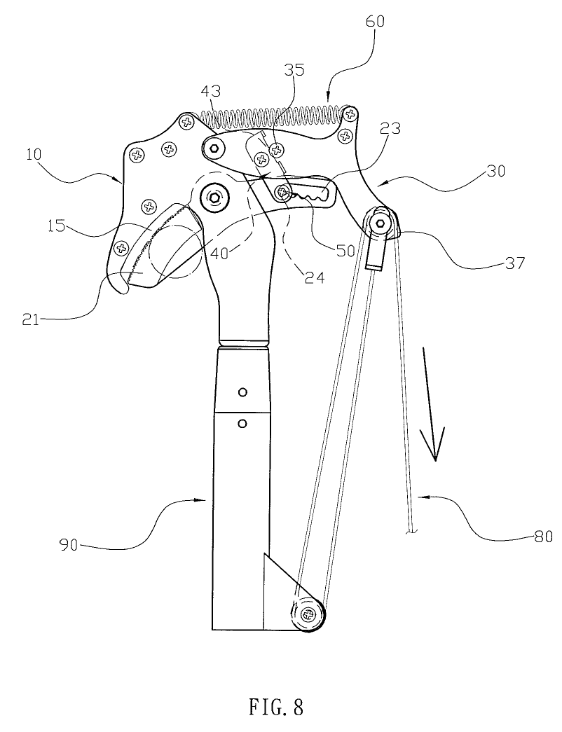

Then, when the pull cord 80 is slightly loosened, the driving bolt 50 is detached from the fourth one of the locking teeth 24 of the sliding slot 23 and is forced into a fifth one of the locking teeth 24 of the sliding slot 23 as shown in FIG. 8. Then, when the pull cord 80 is again pulled downward, the cutting blade 21 of the cutter 20 is moved through a fifth distance and is further extended into the entrance 14 of the fixed seat 10 to shear the object 92 completely as shown in FIG. 8.

Accordingly, when the pull cord 80 is pulled and slightly loosened in a staggered manner, the driving bolt 50 is driven to in turn engage each of the locking teeth 24 of the sliding slot 23 to drive the cutter 20 by multiple stages so as to pierce the object 92 step by step, so that the cutter 20 can shear the object 92 in a multi-stage manner without having to apply a larger force to shear the object 92, thereby facilitating the operator shearing the object 92, and thereby saving the operator's energy. In addition, after the driving bolt 50 is moved backward to proceed the next cutting action, the stop portion 43 of the link 40 is stopped by the stop rod 35 of the drive arm 30 to prevent the cutter 20 from being moved backward by the reaction force applied by the object 92 so that the driving bolt 50 is driven to in turn engage each of the locking teeth 24 of the sliding slot 23 exactly and smoothly, thereby facilitating the operator performing the multi-stage shearing action.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pruning hook, comprising:
a fixed seat;
a cutter pivotally mounted on the fixed seat;
a link connected with the cutter to move the cutter relative to the fixed seat;
a drive arm pivotally mounted on the fixed seat and connected with the link to move the link relative to the fixed seat;
a pull cord connected with the drive arm to move the drive arm relative to the fixed seat; and
a restoring spring biased between the fixed seat and the drive arm;
wherein the fixed seat has a hollow inside formed with a receiving chamber;
the fixed seat has a side formed with a recessed entrance connected to the receiving chamber;
the fixed seat has a mediate portion formed with a first pivot hole and a second pivot hole;
the cutter is pivotally mounted in the receiving chamber of the fixed seat;
the cutter has an upper portion formed with a sliding slot and a lower portion provided with a cutting blade;
the sliding slot of the cutter has a side provided with a plurality of locking teeth;
the cutter has a mediate portion formed with a third pivot hole pivotally connected with the first pivot hole of the fixed seat by a first pivot member;
the drive arm has a hollow inside formed with a mounting chamber pivotally mounted on the fixed seat;
the drive arm has a lower portion formed with a fourth pivot hole pivotally connected with the second pivot hole of the fixed seat by a second pivot member;
the drive arm has a mediate portion formed with a fifth pivot hole and provided with a stop rod;
the link is pivotally mounted in the mounting chamber of the drive arm;
the link has a first end provided with a stop portion abutting the stop rod of the drive arm and a second end formed with a fixing hole;
the link has a mediate portion formed with a sixth pivot hole pivotally connected with the fifth pivot hole of the drive arm by a third pivot member;
the link has a hollow inside formed with an opening to allow passage of the cutter;
the pruning hook further comprises a driving bolt extending through the fixing hole of the link, the opening of the link and the sliding slot of the cutter to combine the link and the cutter and to move the cutter by movement of the link;
the driving bolt is movable in the sliding slot of the cutter and is detachably locked onto one of the locking teeth of the sliding slot.

2. The pruning hook of claim 1, wherein
the fixed seat is composed of two bent sheet plates which are spaced from each other;
the receiving chamber of the fixed seat is defined between the two bent sheet plates;
the fixed seat has a lower portion formed with a bent connecting section which is inserted into an upper end of an extension shank.

3. The pruning hook of claim 1, wherein
the entrance of the fixed seat has a side formed with an anvil;
the cutting blade of the cutter is movable in the receiving chamber of the fixed seat and is extendable into the entrance of the fixed seat to move toward the anvil of the fixed seat.

4. The pruning hook of claim 1, wherein
the cutter has a substantially arc-shaped profile;
the locking teeth of the sliding slot and the cutting blade of the cutter are located at two opposite sides of the cutter.

5. The pruning hook of claim 1, wherein
the drive arm is composed of two substantially T-shaped sheet plates which are spaced from each other;
the mounting chamber of the drive arm is defined between the two sheet plates of the drive arm;
the stop rod of the drive arm is extended through the mounting chamber of the drive arm and is located above the fifth pivot hole of the drive arm;
the fifth pivot hole of the drive arm is located above the fourth pivot hole of the drive arm;
the third pivot hole of the cutter is located between the sliding slot and the cutting blade of the cutter;
the sixth pivot hole of the link is located between the stop portion and the fixing hole of the link;
the second pivot hole of the fixed seat is located above the first pivot hole of the fixed seat, and the first pivot hole of the fixed seat is located above the entrance of the fixed seat.

6. The pruning hook of claim 1, wherein
the fixed seat has a periphery provided with a first fixing member;
the first fixing member of the fixed seat is extended through the receiving chamber of the fixed seat;
the drive arm has an upper portion having a first side provided with a second fixing member and a second side provided with a driving portion;
the second fixing member of the drive arm is extended through the mounting chamber of the drive arm and is located above the stop rod of the drive arm;
the pull cord is connected with the driving portion of the drive arm to drive the drive arm to pivot about the second pivot member;
the restoring spring has an upper end secured on the second fixing member of the drive arm and a lower end secured on the first fixing member of the fixed seat.
